(19) United States
(12) Patent Application Publication
(10) Pub. No.: US 2012/0304021 A1
(43) Pub. Date: Nov. 29, 2012

(54) System and method for generating a signal upon the occurrence of a crash

(76) Inventor: Sunita Mandava, Farmington Hills, MI (US)

(21) Appl. No.: 13/068,939

(22) Filed: May 24, 2011

(51) Int. Cl. G06F 11/32

(52) U.S. Cl. 714/48; 714/E11.188

(57) ABSTRACT

A system 12 and a methodology 90 which cause crash notification information to be directly sent to a user of a hand held device 31 without the need for a central monitoring station.

### GENERAL BACKGROUND

1. Field Of The Invention

The present invention generally relates to a system and a method for generating a signal upon the occurrence of a crash and more particularly, to a system and a method for detecting a vehicular crash and for later generating and transmitting a crash notification signal (which may be asynchronous) directly to a hand held cellular device.

2. Background of the Invention

Vehicular crash detection systems exist and these systems generally detect the occurrence of a vehicular crash and send a notification signal to a central monitoring station. Personnel at the central monitoring station then, upon receipt of the signal, take some predefined action (e.g., calling the police and/or an ambulance).

While such “central monitoring” systems do provide desired functionality, they are costly to the various users, typically requiring a monthly service fee and activation fee. Moreover, these “central monitoring” type systems do not serve all geographic areas of the world.

There is therefore a need and it is a non-limiting object of the present inventions to provide a system and a method for crash detection and signal generation which is much more cost effective than current systems while still providing the desired level of needed functionality, and which further allows such signals to be communicated even in the absence of such central monitoring systems.

### SUMMARY OF THE INVENTIONS

It is a first non-limiting object of the present invention to provide a method and a system for detecting a crash and thereafter generating a crash notification signal.

It is a second non-limiting object of the present invention to provide a method and a system for detecting a vehicular crash and for thereafter generating and communicating a crash detection signal to a hand held cellular type device.

It is a third non-limiting object of the present invention to provide a method for detecting a vehicular crash and for thereafter for automatically generating a crash notification to a hand held cellular type device.

It is a Fourth non-limiting embodiment of the present invention to provide a method to perform authentication of any changes that are being requested of the system.

According to a first non-limiting aspect of the present invention, a system for detecting the occurrence of a crash and for generating and communicating a crash notification signal directly to a hand held cellular device is provided.

According to a second non-limiting aspect of the present invention, a crash detection and notification system is provided. Particularly, the system includes a crash sensor which senses the occurrence of a crash; and a device which is coupled to the crash sensor and which generates and transmits a signal to a hand held device only when the crash occurs.

According to a third non-limiting aspect of the present invention, a method is provided and includes the steps of detecting the occurrence of a vehicular crash; and generating and communicating a crash detecting signal to a hand held device upon the occurrence of the crash.

According to a fourth non-limiting aspect of the present invention, a method is provided to perform an authentication of any changes requested to the notification system.

These and other features, aspects, and advantages of the present inventions will become apparent to those of ordinary skill in the art from a reading of the following drawings and by reference to the following description, including the subjoined claims.

### BRIEF DESCRIPTION OF THE DRAWINGS

FIG. 1 is a block diagram of a system which is made in accordance with the teachings of the preferred embodiment of the invention and which is shown operatively deployed with in a vehicle and used in combination with a cellular system.

FIG. 2 is a block diagram of a system which is made in accordance with the teachings of the preferred embodiment of the invention and which is shown in FIG. 1.

FIG. 3 is a flow chart illustrating the sequence of steps which cooperatively comprise the methodology of the preferred embodiment of the various inventions.

FIG. 4 is a flow chart illustrating the sequence of steps associated with an authentication aspect of the present invention.

### DETAILED DESCRIPTION OF THE PREFERRED EMBODIMENT OF THE INVENTIONS

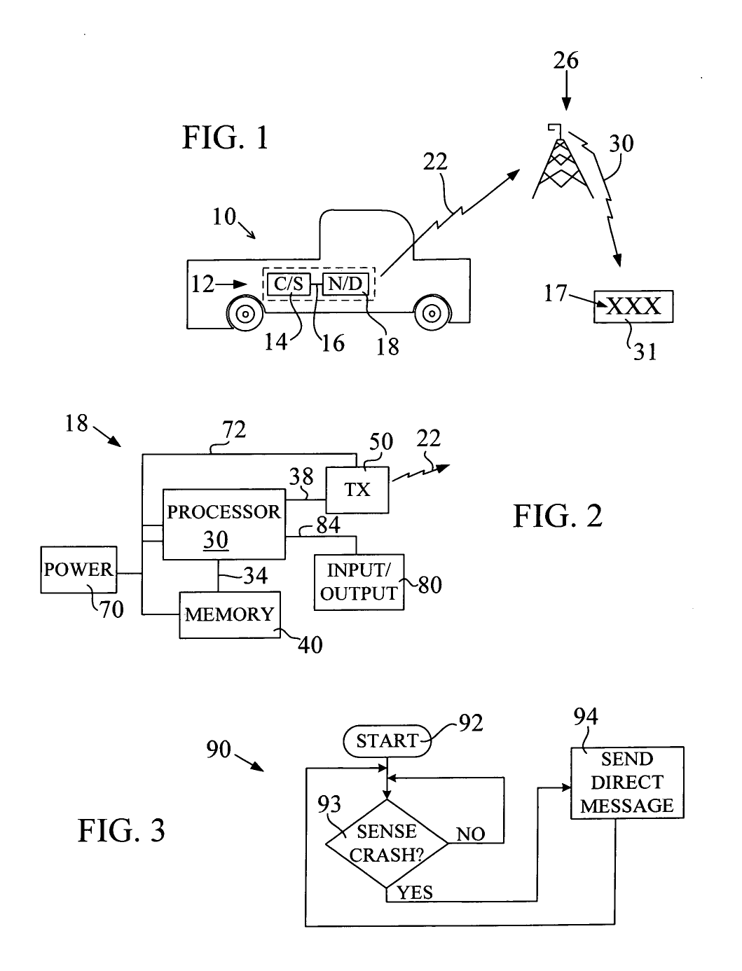

Referring now to FIGS. 1-3, there is shown a vehicle 10 having a system 12 which is made in accordance with the teachings of the preferred embodiment of the invention.

Particularly, the system 12 includes a crash sensor 14 which is operatively deployed within the vehicle 10 and senses the occurrence of a crash of the vehicle 10 and generates a signal on the bus 16. One non-limiting example of such a sensor is a sensor which is manufactured and/or provided by the Delphi Company and which is referred to as a Delphi Electronic Satellite Sensor ESS-G and which is generally described at www.delphi.com/manufacturers/auto/safety/passive/cos/essg/. Of course, other types of crash sensors may be utilized.

System 12 further includes a notification portion 18 which is coupled to the bus 16 and thus is operatively coupled to the crash sensor 14. Portion 18 is operatively deployed within vehicle 10. The notification portion 18 receives the signal on the bus 16 which is generated by the crash sensor 14 and generates a notification signal 22, having information 17. The signal 22 is received by at least one cellular telephone type tower assembly 26 and then the at least one assembly 26 generates a signal 30, having the information 17, sent directly to a hand-held cellular telephone type device 31. In the most preferred, although non-limiting embodiment of the inventions, the signal 22 (the information 17) comprises a “SMS” type signal, but other signals may be utilized.

With particular reference to FIG. 2, the notification portion 18 may comprise, in one non-limiting embodiment of the invention, a processor 30 which is operable under stored program control and a memory portion 40 which is coupled to the processor 30 by the use of bus 34. The memory 40 may store the code associated with the operation of the processor 30 (and of the entire portion 18) and the memory 40 may be read from or accessed by the processor 30 and the processor 30 may have data written into the memory 40. Further, the portion 18 includes a transmitter portion 50 which is coupled to the processor 30 by the use of bus 38 and a electrical power source 70 which is coupled to the processor 30, the memory 40, and the transmitter 50 by the use of bus 72. The power source 70 provides operable power to the processor 30, the memory 40, and the transmitter 50 and, in one non-limiting embodiment of the invention, the power source 70 comprises a vehicular battery. The portion 18 includes an input/output portion 80 which allows a user to communicate information to the processor 30 by use of the bus 84 which couples the portion 80 to the processor 30.

In one non-limiting embodiment of the invention, the information 17 contained within the signal 22 is stored in the memory 40 and may be created by a user and communicated to the processor 30 and then to memory 40 by the busses 84 and 34. Along with the specified information, the user may similarly specify the phone number of the hand held device 31. The phone number information is transmitted to tower assembly 26 along with information 17 as part of signal 22. In one non-limiting embodiment, the portion 18 may comprise an “Air Prime Intelligent Embedded Module” which is provided by the Sierra Wireless Company and which is generally described at www.sierawireless.com/Solutions/automotive.aspx. The specified telephone number is also stored within the memory 40.

Referring now to FIG. 3, there is shown a methodology 90 of the most preferred embodiment of the inventions. Particularly, methodology 90 includes a first step 92 which defines the start of the methodology. Step 92 is followed by step 93 in which processor 30 determines whether the processor 30 received a signal from the sensor 14. If no signal was received, then the processor 30 remains within the step 93. If such a signal was received, then step 93 is followed by step 94 in which the processor 30 obtains the signal information and the phone number from the memory 40 and generates a command to the transmitter portion 50 which is effective to cause the transmitter portion 50 to generate the signal 22 having the specified and previously stored information 17. The signal is directed to a tower assembly, such as cellular telephone assembly 26, where information 17 is then transmitted to the hand held device 31.

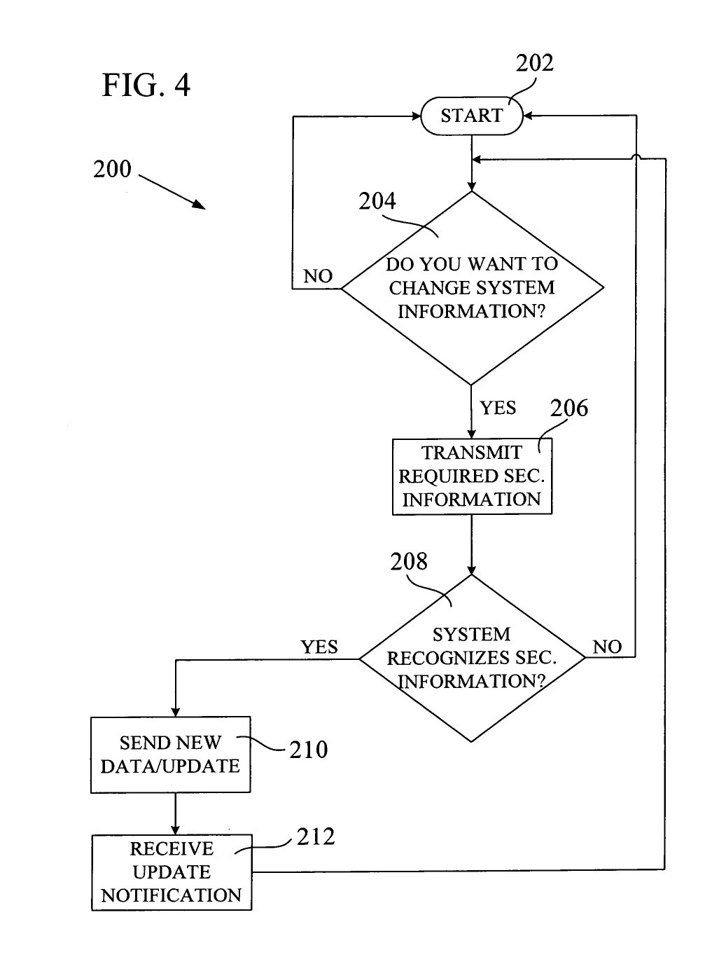

Referring now to FIG. 4, there is shown a flowchart 200 which illustrates a sequence of steps associated with an authentication aspect of the present invention.

Particularly, the authentication process 200 begins with an initial step 202 in which it is desired to change information within the system 18 (e.g., within the memory portion 40). Non-limiting examples of such “information change” or update include the telephone number that the signal 30 is to be directed to.

Step 202 is followed by step 204 in which the user of the system 18 must notify the processor 30, through the input/output portion 80 and bus 84, that it is desired to change/update certain information resident within the system 18. If, in step 204 such an update signal is received by processor 18, then step 204 is followed by step 206. Alternatively, step 204 is followed by step 202.

If an update/change type signal was received by the processor 18, in step 204, then the step 204 is followed by step 206 in which the system user transmits some predetermined authentication code to the processor by the use of input/output portion 80 and the bus 84. Step 208 follows step 206 and, in this step 208, the processor 30 determines whether the transmitted code is authentic. If the transmitted code is determined to be authentic, then step 208 is followed by step 210. Alternatively, step 208 is followed by step 202.

In step 210, the user receives an approval signal from the processor 30, by use of bus 38 and transmitter portion 50, and then the user sends the updated or new data to the processor 30 by use of the input/output portion 80 and the bus 84. Once the received data is placed into memory 40, the processor 30 sends a notification signal to the user, in step 212 (which follows step 210). This notification signal is sent to the user by use of transmitter portion 50 and bus 38. Step 212 is followed by step 200.

As can be readily appreciated, the present inventions define a system in which a crash notification signal is directly sent to a hand held device 31 and which obviates the need for a central control station. The present inventions are not limited to the exact construction and methodology which has been previously explained, but that various modifications and changes may be made to the various inventions without departing from the spirit and the scope of the inventions as they are further delineated in the following claims. It should further be appreciated that vehicle 10 maybe of any type and form. Further, in another non-limiting embodiment, GPS (global positioning system) type of information may be included within the information 17. That is, processor 30 may sense/calculate the position of vehicle 10 and transmit this information to tower assembly 26 when it is then sent to hand held device 31. Moreover, it shall be apparent that system 18 may operate within any cellular telephone or device area and thus there is no need for a central station. Since there are many more cellular tower assemblies 26 than central monitoring stations, it is readily apparent that the foregoing system 10 allows for crash notification functionality over a wide geographic range, far in excess of that provided by current “central station” strategies/implementations, and at a fraction of the user costs.

What is claimed is:

1) A system for detecting the occurrence of a crash and for generating and communicating a crash notification signal directly to a hand held cellular device.

2) A crash detection and notification system comprising a crash sensor which senses the occurrence of a crash; and a device which is coupled to the crash sensor and which generates and transmits a signal to a hand held device only when said crash occurs.

3) A method comprising the steps of detecting the occurrence of a vehicular crash; and generating and communicating a crash detecting signal to a hand held device upon the occurrence of said crash.
